(19) United States
(12) Patent Application Publication
(10) Pub. No.: US 2004/0148260 A1
(43) Pub. Date: Jul. 29, 2004

(54) Information processing apparatus, information processing system, information processing method, and program product

(75) Inventors: Tomohiro Matsuda, Guangzhou (CN); Rikio Shiba, Kanagawa (JP)

Correspondence Address: Canon U.S.A. Inc., Intellectual Property Department, 15975 Alton Parkway, Irvine, CA, 92618-3731, US

(73) Assignee: Canon Kabushiki Kaisha, Ohta-ku (JP)

(21) Appl. No.: 10/735,108

(22) Filed: Dec. 12, 2003

(30) Foreign Application Priority Data
Dec. 17, 2002 (JP) 2002/365832

(51) Int. Cl. G06F 17/60

(52) U.S. Cl. 705/57

(57) ABSTRACT

A technology for easily and accurately identifying a counterfeit program is provided. Image data and product-name data, which serve as product data, are input. A determination is made as to whether or not the input product data includes a registered trademark that is attached to genuine products and that is not attached to third party products as first information, and a determination is made as to whether or not the input product data includes a micro character that is attached to only genuine products as second information for counterfeit protection. When the input product data includes the first information and does not include the second information, it is determined that the product is a counterfeit product.

### BACKGROUND OF THE INVENTION

1. Field of the Invention

The present invention relates to a technology for identifying a counterfeit product.

2. Description of the Related Art

Recently, counterfeits of genuine products have become showing up in the market for products, such as toner containers, packages, and cartridges for refilling toner for printers. Various technologies are known for identifying counterfeit products.

For example, Japanese Unexamined Patent

Application Publication Nos. 2000-148950 and 2000-11114 disclose technologies in which a device for reading contactless tags or product tags and the memory information of the tags is used and a server determines whether or not products are genuine products over a network. Japanese Unexamined Patent Application Publication No. 2001-341810 discloses a technology in which a terminal connected to a network or a mobile terminal is used to read the tag image of a genuine product from a server and a client or salesperson compares the tag image with the tag of an actual product to determine the authenticity of the product.

However, such systems of the related art only determine whether or not a product is genuine product and thus cannot identify a counterfeit product among products in which compatible products (so-called “third party products”) as well as genuine products and counterfeit products exist for consumables for office equipment and personal-computer peripheral equipment, automotive parts, computer memories, and the like.

Currently, a regulatory authority collects problem information about counterfeit products, by means of reports, complaints, and the like from manufactures, sellers, consumers, and the like. This method, however, is quite inefficient, because it is uncertain whether or not such complaints are really concerned with counterfeit protects when they are filed. Thus, when only information that is confirmed as being a counterfeit product by a determination system is reported to the regulatory authority and a database on the determination system can be referred to in various forms, the regulatory activities at the authority become considerably efficient. Such an arrangement can be utilized to meet diverse purposes. For example, a specific region, a specific product, or the like is specified when referring to the database, to allow for regulatory activities with a region on alert, a product, or the like being specified.

### SUMMARY OF THE INVENTION

In view of the foregoing situations, an object of the present invention is to provide a technology for easily and accurately identifying a counterfeit product.

The present invention provides an information processing apparatus for determining whether or not a product is a counterfeit product in accordance with product data. The information processing apparatus includes an inputting section, a first determining section, a second determining section, and a third determining section. The inputting section inputs product data. The first determining section determines whether or not the product data input by the inputting section includes first information that is attached to a genuine product and that is not attached to a third party product. The second determining section determines whether or not the product data input by the inputting section includes second information that is attached to only the genuine product. The third determining section determines that a product is a counterfeit product when the product data input by the inputting section includes the first information and does not include the second information.

The product data may include image data.

Preferably, the product data includes image data, and the first determining section determines whether or not the image data includes, as the first information, an image that is protected by an intellectual property right held by a manufacture of the genuine product.

The image may include a registered trademark.

Preferably, the product data includes image data, and the second determining section determines whether or not the image data includes, as the second information, an image that does not exist in a counterfeit product.

The image may include a micro-character.

The inputting section may input a determination request and the product data from another terminal, and the information processing apparatus may further include a transmitting section for transmitting a determination result obtained by the third determining section to the another terminal.

Preferably, the product data includes item data that indicates a type of product, and the information processing apparatus further includes a first database in which the first information is stored for each type of product and a second database in which the second information is stored for each type of product. The first determining section searches the first database in accordance with the item data to retrieve the first information and determines whether or not the input product data includes the retrieved first information. The second determining section searches the second database in accordance with the item data to retrieve the second information and determines whether or not the input product data includes the retrieved second information.

Preferably, the information processing apparatus further includes a transmitting section for transmitting a determination result to a predetermined terminal when the third determining section determines that the product is a counterfeit product.

Preferably, the inputting section inputs user information, a determination request, and the product data from a user terminal, and the information processing apparatus further includes a transmitting section for transmitting a determination result obtained by the third determining section and the user information to a predetermined terminal.

The present invention provides an information processing system for determining whether or not a product is a counterfeit product in accordance with product data. The information processing system includes the above-described information processing apparatus, a user terminal, and a counterfeit-product's regulatory authority terminal. The information processing apparatus determines whether or not the product is a counterfeit product in accordance with product data transmitted from the user terminal. When the third determining section determines that the product is a counterfeit product, the information processing apparatus transmits a notification indicating that the product is a counterfeit product to the counterfeit-product's regulatory authority terminal.

The present invention provides an information processing method for determining whether or not a product is a counterfeit product in accordance with product data. The information processing method includes an inputting step of inputting product data and a first determining step of determining whether or not the product data input in the inputting step includes first information that is attached to a genuine product and that is not attached to a third party product. The information processing method further includes a second determining step of determining whether or not the product data input in the inputting step includes second information that is attached to only the genuine product and a third determining step of determining that a product is a counterfeit product when the product data input in the inputting step includes the first information and does not include the second information.

The present invention provides a program that causes a computer to execute the individual steps included in the above-described information processing method.

The present invention provides a computer-readable storage medium in which the program is stored/recorded.

According to the present invention, it is possible to provide a technology for easily and accurately identifying a counterfeit product.

According to the present invention, a consumer or a seller that has procured a product does not require a special apparatus and can use their own terminals to determine whether or not the product is a counterfeit. The transmission of a notification indicating a determination result to the consumer or the like can help the consumer or the like to avoid future inconvenience. That is, upon receiving a notification indicating that a determination result shows a counterfeit product, the consumer or the seller can autonomously choose another supplier of the product. This can avoid the risk of associated equipment breakdown or failure which results from the use of an inferior counterfeit product.

When a customhouse or the like utilizes this determination system, it is possible to provide support to customs personnel in order to determine counterfeit products and this determination system will also be of help for the personnel to prevent misjudgment.

This determination system not only can protect consumers and sellers but also can protect brand-name confidence of manufactures.

Further objects, features and advantages of the present invention will become apparent from the following description of the preferred embodiments with reference to the attached drawings.

### BRIEF DESCRIPTION OF THE DRAWINGS

FIG. 1A is a schematic view illustrating the overall configuration of a counterfeit-product determination system according to an embodiment of the present invention.

FIG. 1B is a block diagram illustrating the internal configuration of a terminal included in the counterfeit-product determination system.

FIG. 2 is a chart of processing performed by the counterfeit-product determination system.

FIG. 3 is a chart of processing for user registration in the counterfeit-product determination system.

FIG. 4 shows an example of a user-registration screen.

FIG. 5 is a table illustrating an example of a user information database.

FIG. 6 is a flow chart of counterfeit-product determination processing performed by a main server of the counterfeit-product determination system.

FIGS. 7A and 7B illustrate the counterfeit-product determination processing performed by the main server of the counterfeit-product determination system.

FIG. 8 illustrates the counterfeit-product determination processing performed by the main server of the counterfeit-product determination system.

FIGS. 9A and 9B illustrate the counterfeit-product determination processing performed by the main server of the counterfeit-product determination system.

FIG. 10 is table illustrating a counterfeit-product determination database that is managed by the main server of the counterfeit-product determination system.

FIG. 11 illustrates an example of a screen when the counterfeit-product determination database on the main server is referred to by an authority terminal in the counterfeit-product determination system.

FIG. 12 illustrates an example of a screen when the counterfeit-product determination database on the main server is referred to by the authority terminal in the counterfeit-product determination system.

FIG. 13 illustrates an example of a screen when the counterfeit-product determination database on the main server is referred to by the authority terminal in the counterfeit-product determination system.

FIG. 14 illustrates one example of a log-in screen in the counterfeit-determination system.

FIG. 15 illustrates one example of a counterfeit-determination request screen in the counterfeit-product determination system.

FIG. 16 illustrates one example of the counterfeit-determination request screen in the counterfeit-product determination system.

FIG. 17 illustrates one example of the counterfeit-determination request screen in the counterfeit-product determination system.

FIG. 18 shows an exemplary message in a determination-result notification mail transmitted from the main server to the user terminal in the counterfeit-product determination system.

FIG. 19 shows another exemplary message in the determination-result notification mail transmitted from the main server to the user terminal in the counterfeit-product determination system.

FIG. 20 shows an exemplary message in a determination-result notification mail transmitted from the main server to the authority terminal in the counterfeit-product determination system.

FIG. 21 is a flow chart illustrating the overview of the counterfeit-product determination processing.

### DESCRIPTION OF THE PREFERRED EMBODIMENTS

Preferred embodiments of the present invention will be described below in detail for illustrative purposes with reference to the attached drawings. The present invention, however, is not intended to restrict the scope thereof to only the relative arrangements of elements, displayed screens, and the like which are described in the embodiments below, unless otherwise specifically stated. A user herein is not only limited to an end user of a product but also represents all concepts that need determination of a counterfeit product, and thus includes, for example, a dealer and a customhouse. Also, third party products herein refer to compatible products which are neither genuine products nor counterfeit products, and are typically fabricated by a manufacturer different from the manufacturer of the genuine products.

Overview

First, the overview of a counterfeit-product determination system according to an embodiment of the present invention will be described.

The known technologies determine whether or not a product in question is a genuine product, based on whether the product has feature information, such as a hidden character, watermark, or micro character, that is attached to only genuine products. With only such feature information, however, while it is possible to determine that a product is a genuine product, it is impossible to distinguish between a third party product and a counterfeit product. Thus, with respect to products in which genuine products, third party products, and counterfeit products exist, it is impossible for the known technologies to identify only a counterfeit product.

Thus, a system according to the present embodiment determines that a product having feature information that does not exist in third party products is a counterfeit product. This system herein uses an image that is protected by an intellectual property right, such as a trademark right, as one example of feature information that is attached to genuine products or counterfeit products but is not attached to third party products. Thus, a determination is made as to whether or not a registered trademark or notable mark is attached to a product in question. When it is determined that such a mark attached thereto, the product is identified as a genuine product or a counterfeit product imitating the genuine product. This is because legitimate third party products should not be manufactured to imitate the genuine products and thus, even if such a mark is attached to third party products, it should be attached as an auxiliary mark.

In addition, feature information, such as a hidden character, watermark, or micro character, that is attached to only genuine products is used to determine whether a product is a genuine product or a counterfeit product.

This technique can detect counterfeit products even among products in which genuine products, third party products, and counterfeit products can exist.

Configuration of Overall System

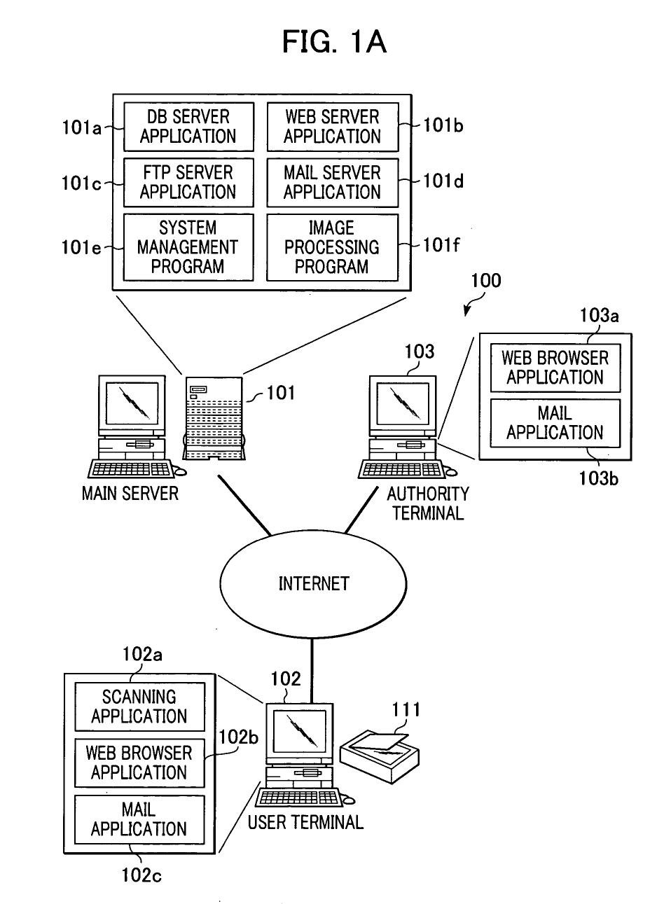

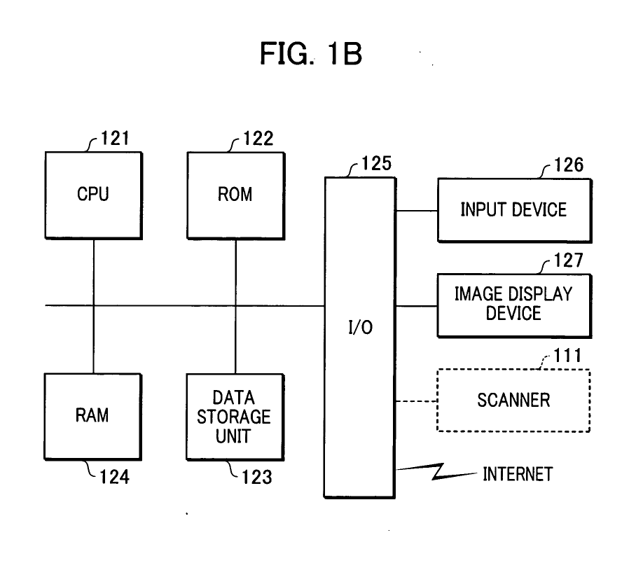

FIG. 1A is a schematic diagram of a counterfeit-product determination system according to an embodiment of the present invention.

This system 100 includes a main server 101, a user terminal 102 serving as a client machine, and an authority terminal 103 provided at a regulatory authority, and these terminals are interconnected over the Internet. A scanner 111 is connected to the user terminal 102, so that a user can transmit image data read with the scanner 111 to the main server 101 over the Internet via the user terminal 102. The main server 101 can also perform counterfeit-product determination processing. If the main server 101 detects a counterfeit product, it notifies the authority terminal 103 of the result of the detection.

The main server 101 includes a DB (database) server application 110a, a web server application 10b, an FTP server application 10c, a mail server application 101d, and a system management program 101e that controls and manages those applications. The main server 101 further includes an image processing program 110f for determining whether or not a product is a counterfeit based on image data.

The user terminal 102 also includes a scanning application 102a for controlling the scanner 111, a web browser application 102b for displaying web content offered by the main server 101 and for transmitting data, and a mail application 102c for receiving mail from the main server 101.

In addition, the authority terminal 103 includes a web browser application 103a and a mail application 103b.

Needless to say, the server and the terminals also include an OS (operating system) and other applications.

While the main server 101 is illustrated as a single PC (personal computer) in this case, the individual applications described above may be provided in different PCs to function as one entire server system.

Hardware Configuration

Next, the internal hardware configurations of the server and the terminals will be described. Since all of the basic configurations of the server and the terminals are analogous, the hardware configuration of a PC that can serve as the user terminal 102 will now be described as a typical example with reference to FIG. 1B. In FIG. 1B, reference numeral 121 indicates a CPU for computation and control, and the CPU 121 controls the entire apparatus. Reference numeral 122 indicates a ROM for storing constant values, a program executed by the CPU 121, and the like. Reference numeral 123 indicates a data storage unit, such as a hard disk. Reference numeral 124 is a RAM (random access memory) for temporal storage and includes a program-loading region or the like for storing a program loaded.

Reference numeral 125 is an input/output (I/O) interface for inputting and outputting data from and to external equipment. Through the I/O interface 125, the PC exchanges data with another computer (a server or client) over the Internet.

Reference numeral 126 is an input device, such as a keyboard and/or a mouse, for receiving data entered by an operator, and 127 is a display device, such as a CRT (cathode ray tube) display or a liquid crystal display, for displaying an image. The input device 126 and the display device 127, as well as the scanner 111, are connected to the I/O interface 125.

It is to be noted that each block represents a functional separation but not the number of devices. For example, the data storage unit 123 may be constituted by multiple types of storage media, including a hard disk, a CD-ROM, and a DVD-ROM. The I/O interface 125 may also be constituted by multiple types of hardware, including hardware for the input device 126, hardware for the display device 127, hardware for the scanner 111, and hardware for communication.

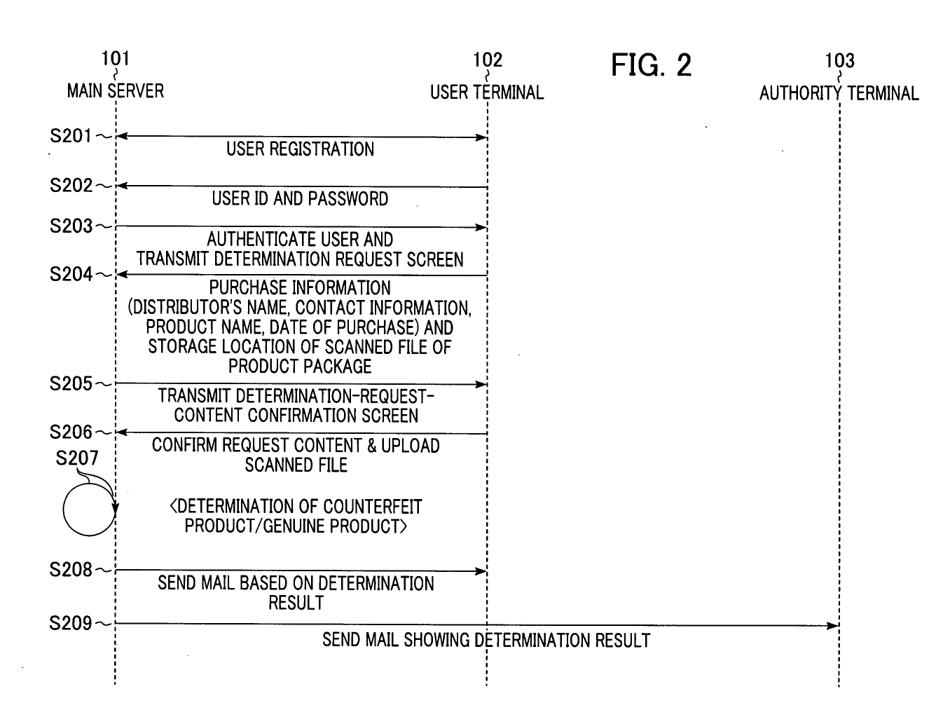

FIG. 2 is a chart illustrating data exchange between the main server 101 and the user terminal 102 and between the main server 101 and the authority terminal 103.

The main server 101 requests user-unique information before offering a counterfeit-product determination service. Thus, an unregistered user, before receiving the service, has to undergo a user registration with the main server 101.

First, in step S201, the DB server application 101a of the main server 101 registers user information, transmitted from the web browser application 102b of the user terminal 102, in a user information database (not shown). It is sufficient that this user registration is performed only once for each user. A user who has already been registered, therefore, starts processing at step S202.

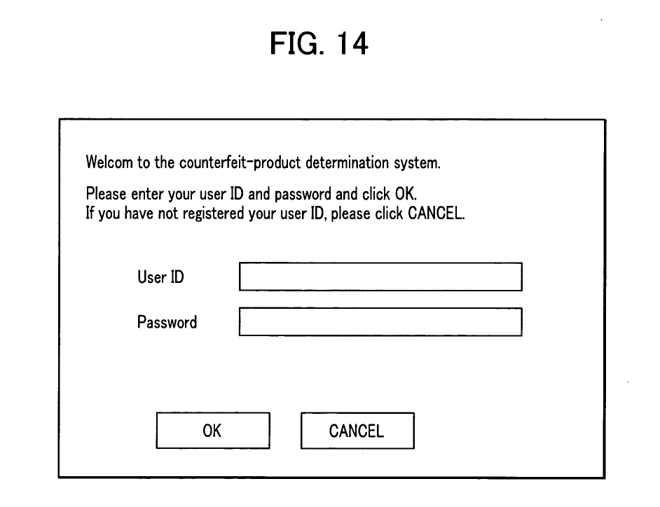

Next, in step S202, the web server application 101b of the main server 101 transmits initialization-screen data to the user terminal 102, so that the display device at the user terminal 102 displays a log-in screen shown in FIG. 14. When the user enters information including his or her user ID and password in corresponding text fields using the input device 126 such as a keyboard or the like, the user terminal 102 transmits the information, which is entered in the text fields shown in FIG. 14, to the main server 101. In accordance with the information, the system management program 101e of the main server 101 performs authentication. When the result of the authentication shows that the user is a registered user, the process proceeds to step S203.

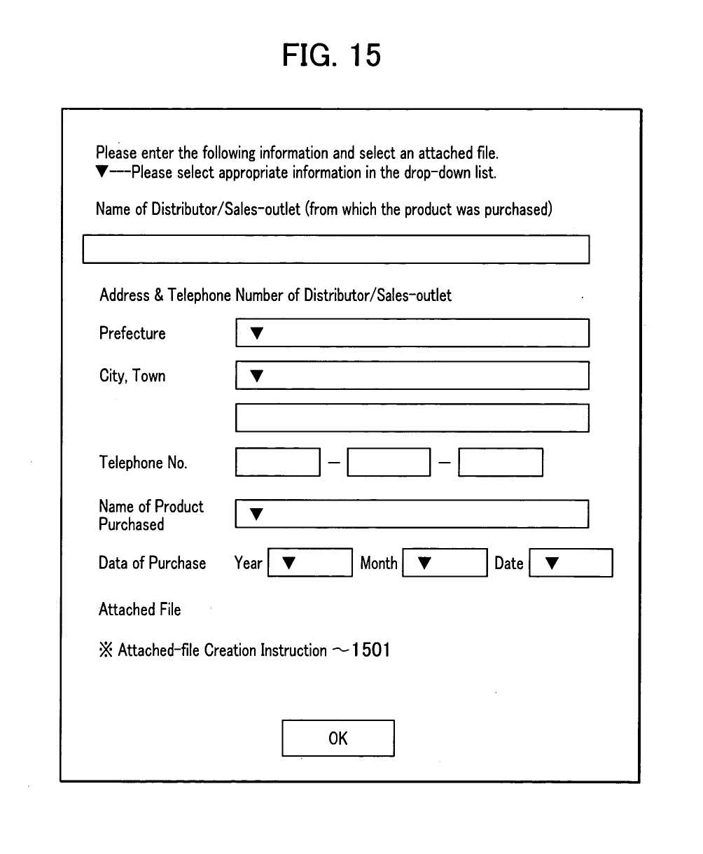

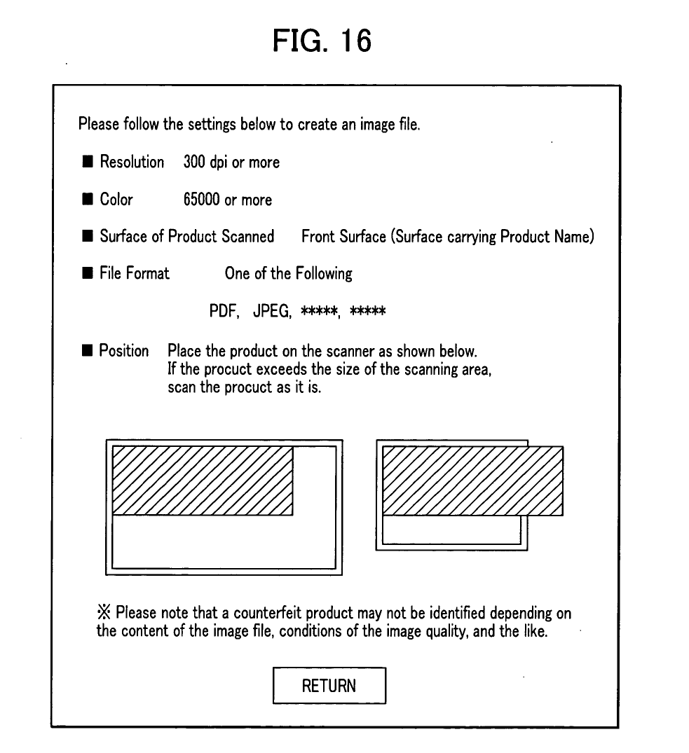

In step S203, the DB server application 110a of the main server 101 transmits determination-request-screen data to the user terminal 102, so that the display device at the user terminal 102 displays a screen shown in FIG. 15. When an attached-file creation instruction 1501 is selected with the input device such as a mouse while the screen shown in FIG. 15 is being displayed at the user terminal 102, the user terminal 102 transmits, to the main server 101, information indicating that the instruction 1501 is selected. In response to the information, the main server 101 transmits instruction screen data to the user terminal 102. The user terminal 102 receives the instruction screen data and then causes the display device to display an image shown in FIG. 16.

When the user enters information in the fields shown in FIG. 15 with a keyboard or the like and specifies the storage location of an attached file (package-image data of a product that the user desires to have determined whether or not it is a counterfeit product), in step S204, the user terminal 102 transmits, to the main server 101, a sales-outlet/distributor's name, address, telephone number, the name of product purchased, date of purchase, and the file name of a scanned image of the product package which are entered in the fields shown in FIG. 15.

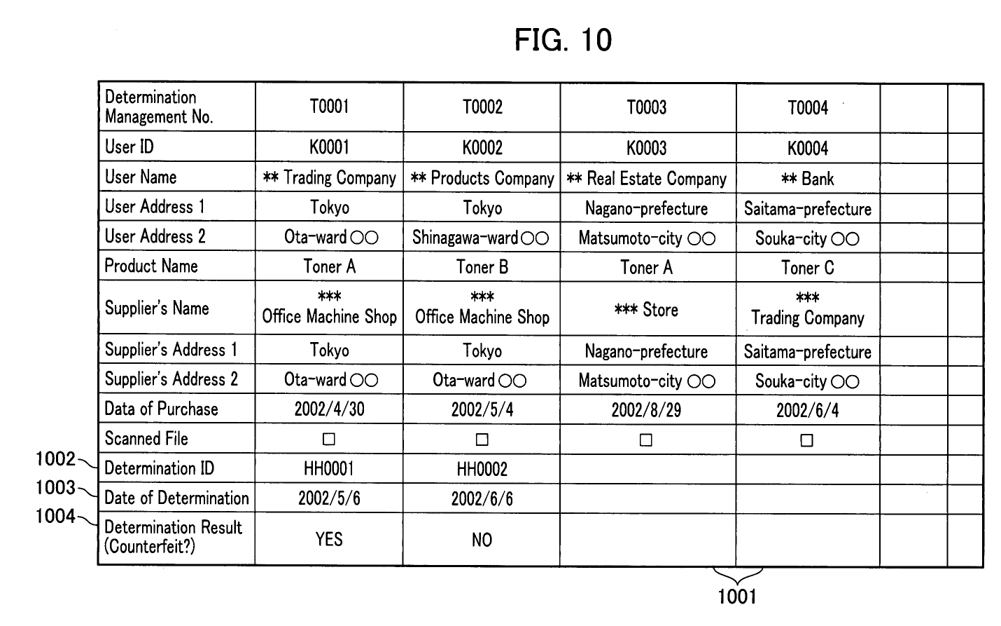

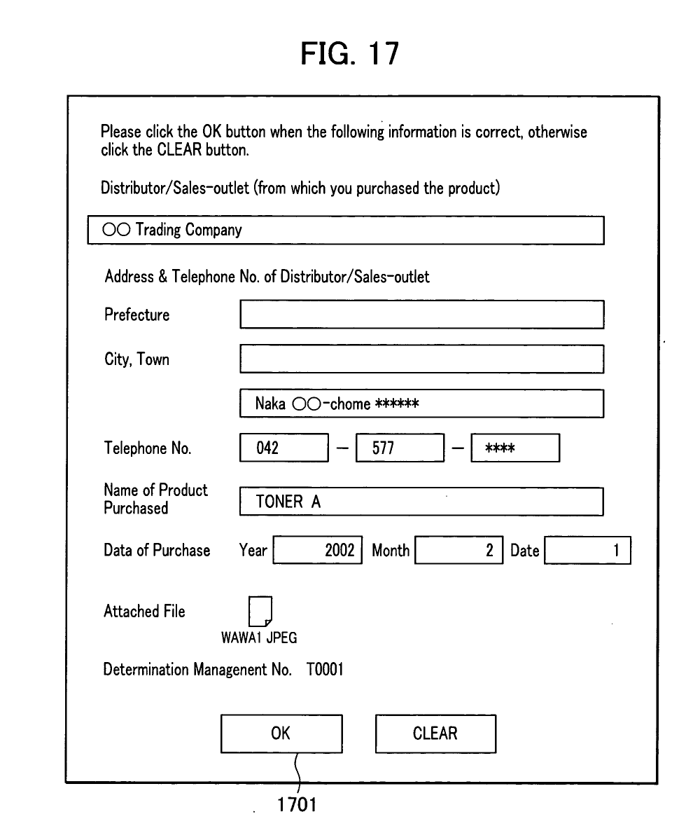

Upon receiving the information, in step S205, the main server 101 transmits determination-request-content confirmation screen data to the user terminal 102, so that the display device at the user terminal 102 displays a screen shown in FIG. 17. When an OK button 1701 is selected with the input device such as a mouse or the like while the screen shown in FIG. 17 is being displayed on the display device at the user terminal 102, the user terminal 102 transmits a request-content confirmation notification and scanned-image data to the main server 101. The FTP server program 101c of the main server 101 receives the scanned-image data from the user terminal 102 and stores the data in an image database, which is not shown. The DB server program 101a of the main server 101 registers, in a determination result database, the personal information of the logged-in user, the information entered in the screen shown in FIG. 15, and a path for the scanned-image data stored in the image database, in conjunction with a determination management number, to thereby create a table as shown in FIG. 10. Since no counterfeit-product determination processing has yet been performed at this point, determination ID fields 1002, determination data fields 1003, determination result fields 1004 in columns 1001, which are indicated by determination management numbers T1003 and T1004, are left blank in FIG. 10.

With this as a trigger, in step S207, the main server 101 performs processing for determining whether the product in question is a counterfeit-product or a genuine-product, based on the received product name and image data.

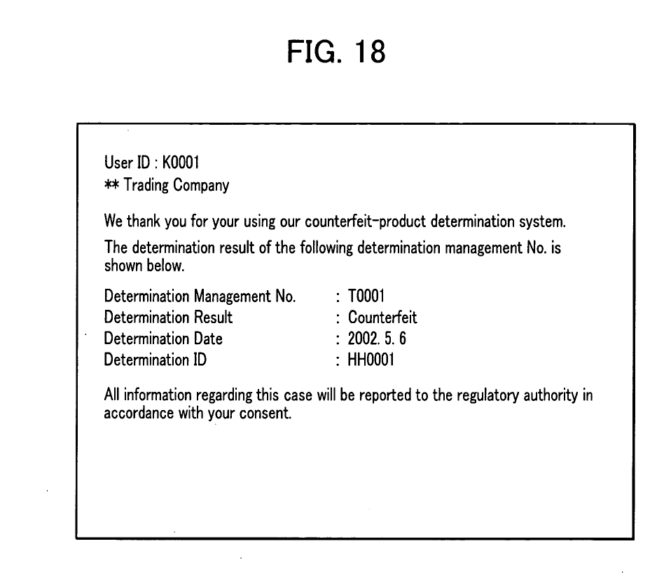

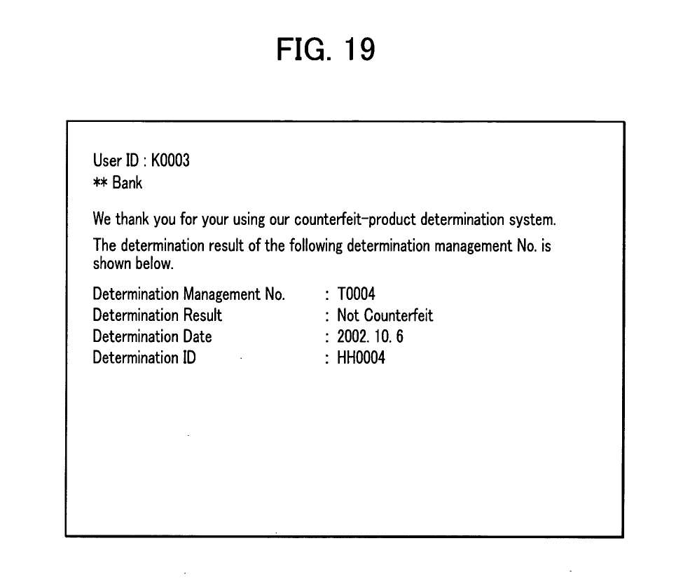

In step S208, the main server 101 uses the mail server application 110d to transmit mail based on the determination result obtained in step S207 to the user terminal 102. When it is determined in step S207 that the product in question is a counterfeit product, mail having a message as shown in FIG. 18 is transmitted. When it is otherwise determined that the product in question is not a counterfeit product but a genuine product or a third-party product, mail having a message as shown in FIG. 19 is transmitted.

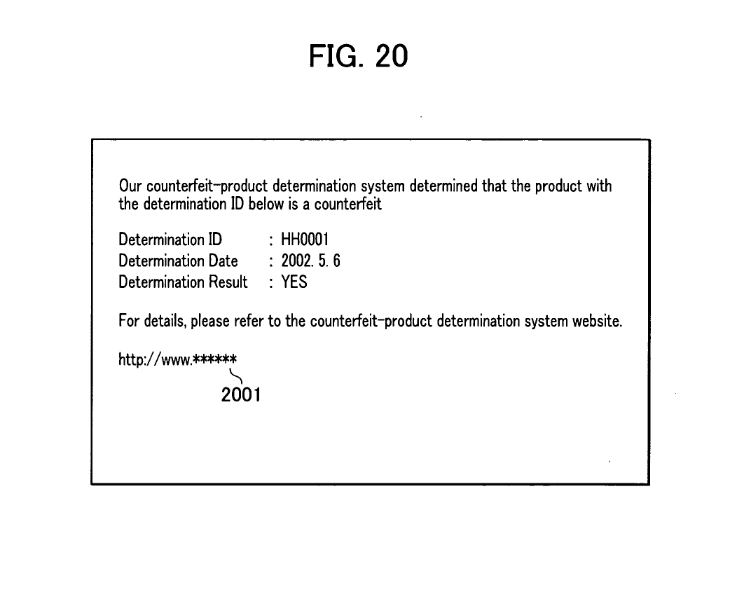

In addition, when it is determined in step S207 that the product in question is a counterfeit product, in step S209, the main server 101 uses the mail server application 110d to further transmit mail having a message as shown in FIG. 20 to the authority terminal 103. Upon receiving such mail, the authority terminal 103 starts the web browser application 103a to access a URL 2001 provided in the mail, so that the regulatory authority can refer to data including the determination request content and the determination result, which are stored on the main server 101.

The above described is the flow of overall processing when the counterfeit-product determination system according to the present embodiment is utilized.

User Registration Processing

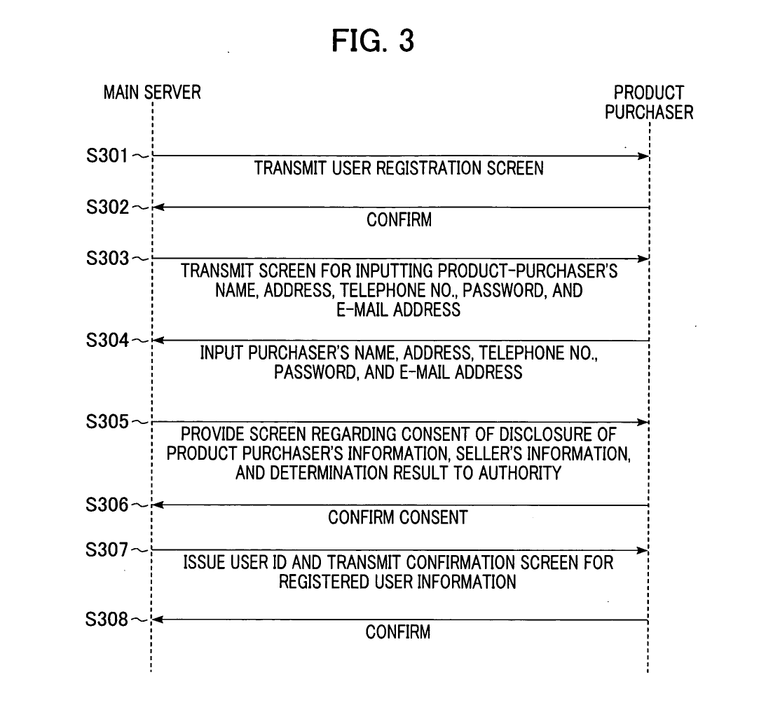

Next, user registration processing will be described with reference to FIGS. 3 to 5.

FIG. 3 is a chart illustrating processing performed between the main server 101 and the user terminal 102 during the user registration.

Referring to FIG. 3, in step S301, the main server 101 transmits user-registration-screen data to the user terminal 102, so that the web browser application 102b of the user terminal 102 causes a message “Would you like to continue with user registration?” to be displayed on the display device in accordance with the received data.

In step S302, the user terminal 102 transmits a notification for performing user registration to the main server 101, and then the process proceeds to step S303. In step S303, the DB server application 101a of the main server 101 transmits, to the user terminal 102, screen data including text fields for entering user's personal information, such as a product purchaser's name, address, telephone number, password, and mail address. In accordance with the received information, the web browser application 102b of the user terminal 102 causes a personal-information input screen to be displayed on the display device. In step S304, in response to the screen, when personal information is entered with the input device 126 of the user terminal 102 and a register button is selected, the user terminal 102 transmits the data to the main server 101.

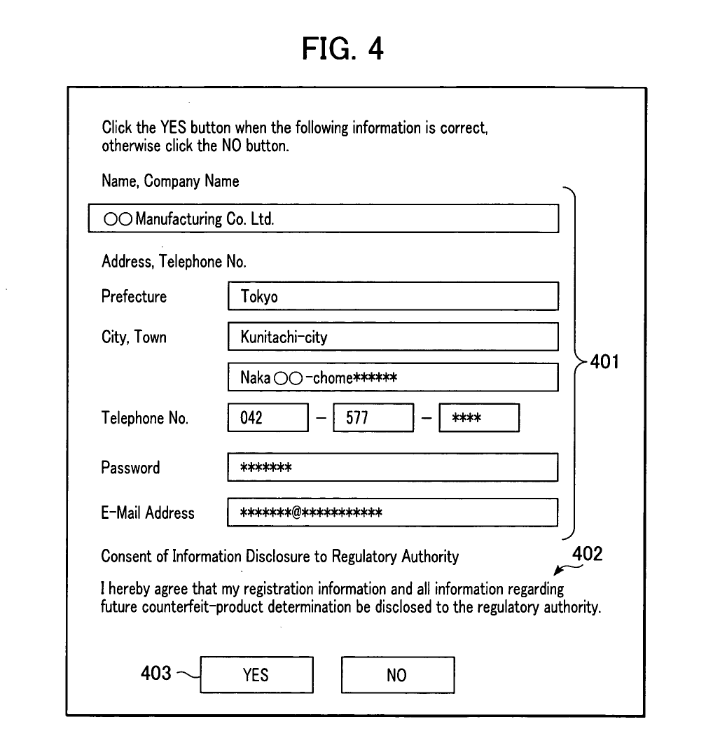

In response to the data, in step S305, the DB server application 110a of the main server 101 transmits confirmation screen data to the user terminal 102. The user terminal 102 receives the confirmation screen data and the web browser application 102b thereof causes a personal-information confirmation screen as shown in FIG. 4 to be displayed on the display device 127. In this case, in addition to a personal-information confirmation image 401 as shown in FIG. 4, a message 402 for consent of information disclosure to the regulatory authority is also displayed on the display device 127.

In step S306, the user selects a YES button 403 to transmit consent confirmation information to the main server 101, so that the main server 101 obtains not only accurate personal information data but also the consent of permitting counterfeit-product determination information to be disclosed to the regulatory authority. In addition, in step S307, the main server 101 issues a user ID for the user terminal 102 and transmits the registered user information together with the issued user ID. In step S308, the user selects a confirm button to transmit confirmation information to the main server 101.

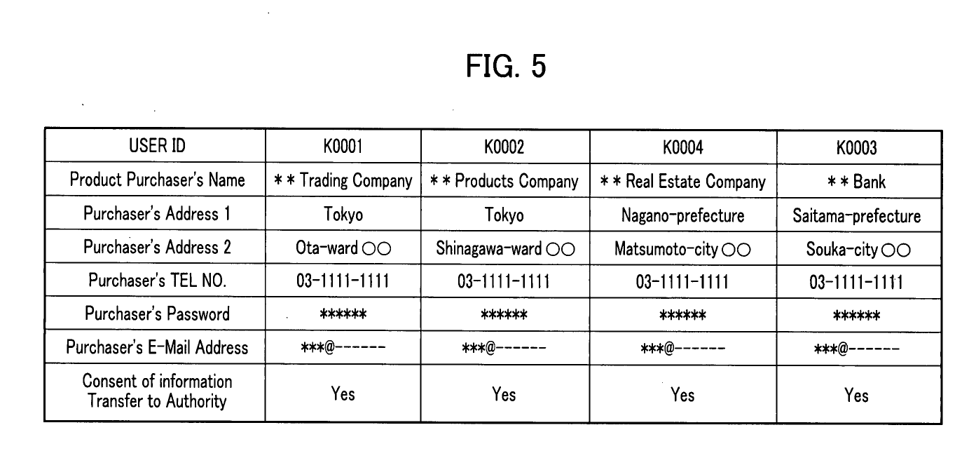

Based on user's information registered in that manner, the DB server application 110a of the main server 101 generates a table as shown in FIG. 5.

Although the main server 101 prompts the user terminal 102 to input personal information, such as an address and telephone number, as initial requirements for counterfeit-product determination in this case, the present invention is not limited thereto. For example, the main server 101 may prompt input of only contact information, such as an e-mail address, which makes it difficult to identify an individual, to perform counterfeit-product determination on a condition of virtual anonymity.

Further, the consent of information transfer to the authority may be performed on a screen different from the one used for the personal-information verification. In such a case, the system of the present invention can be made available to users who do not consent to information transfer to the authority. In addition, the consent of information transfer to the authority may be requested every time a user uses the system rather than just at the time of user registration. Counterfeit-product Determination Processing

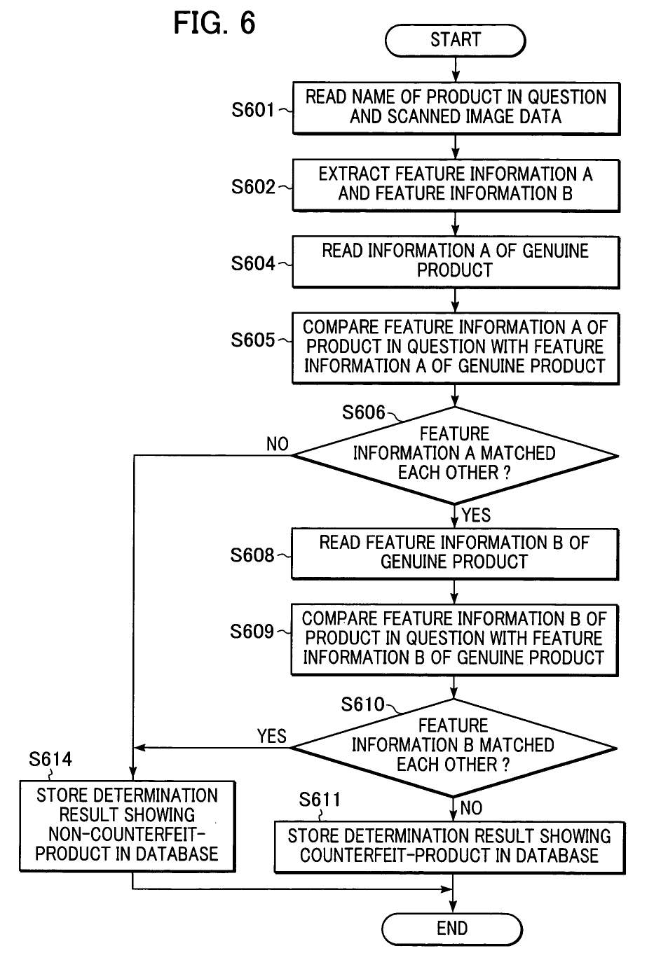

The counterfeit-product determination processing performed at the main server 101 will now be described with reference to FIGS. 6 to 13.

FIG. 6 is a flow chart showing processing that is performed by the image processing program 101f of the main server 101.

Referring to FIG. 6, first, in step S601, the name of a product to be identified and a path for corresponding scanned image data are read from the database shown in FIG. 10, and, in accordance with the path, the scanned image data is read from the image database.

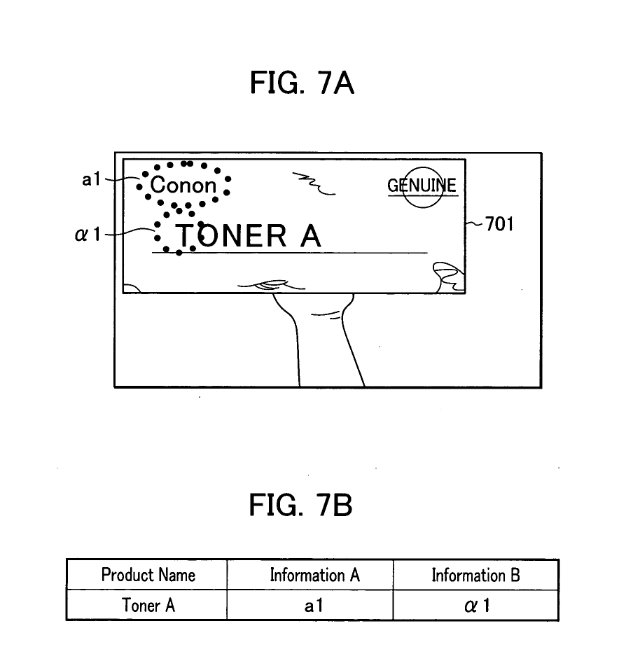

FIG. 7A is a schematic view illustrating one example of scanned image data. Reference numeral 701 indicates a read image of the package of toner A.

Next, in step S602, image processing, which corresponds to the product name, is performed on the scanned image data to extract feature information. Two types of feature information are extracted in this case. One is information A regarding an image protected by an intellectual property right, such as a trademark right, right of design, or copyright. The other is information B, such as a micro character, that is unique to genuine products.

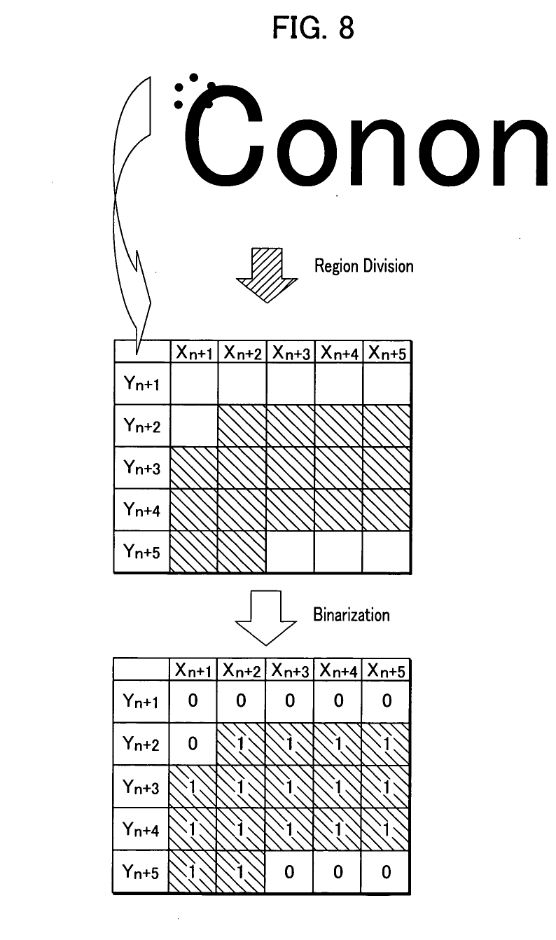

In the example of FIG. 7A, a mark “Conon” is extracted as information A from a read image 701 and a character “T” is extracted as information B. As shown in FIG. 7B, these images are then stored as data al and data al. A known method may be used to extract information A. For example, as shown in FIG. 8, a region that includes a characteristic character or illustration which is protected by an intellectual property right is specified and is divided into a plurality of cells, which are then binarized depending on whether or not the color within the cells is background color, so that data “0” (e.g., background color) or “1” (e.g., non-background color) is stored on the main server 101 for each cell. In this case, a base point for creating axes for identifications of cells may be set as appropriate.

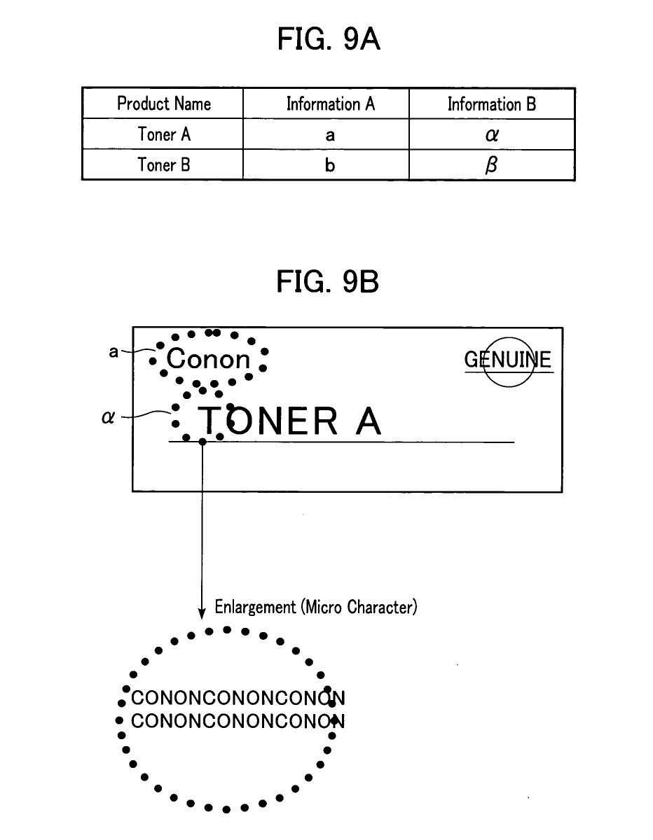

Next, in step S604, information A of genuine products corresponding to the product name read in step S601 is read. Information A and information B of the genuine products are stored in a table shown in FIG. 9A in association with corresponding product names.

For the case of FIGS. 7A and 7B, since the product name is toner A, data a is read as information A from the table shown in FIG. 9A.

In step S605, information A extracted in step S602 and information A read in step S604 are compared with each other. For the case of FIGS. 7A and 7B, data al and data a are compared with each other.

When the result of the comparison shows that the two pieces of data do not match each other, it is determined that the product in question is neither a genuine product nor a counterfeit-product imitating the genuine product, because the scanned image data transmitted from the user does not include an image protected by an intellectual property right. The process then proceeds from step S606 to step S614. In step S614, “NO” indicating that the product in question is not a counterfeit product is written in the corresponding determination result field 1004 in the table shown in FIG. 10. At the same time, a determination ID and the date of determination are written in the corresponding determination ID field 1002 and the determination date field 1003 as well.

For the image comparison performed in step S605, a known method for character recognition through OCR may be used. Also, while a complete match may be determined as the two pieces of data matching each other, a determination indicating that the same image is attached with a predetermined reliability, even without a complete match, may also be determined as the two pieces of data matching each other.

On the other hand, when the two pieces of data match each other in step S606, in step S608, information B of the genuine product that corresponds to the product name read in step S601 is read from the table shown in FIG. 9A.

For determination of the scanned image shown in FIG. 7A, data a is read as information B for toner A. Data a may be data indicating, for example, the presence of a micro character, as shown FIG. 9B.

In step S609, information B extracted in step S602 and information B read in step S608 are compared with each other. For the case of FIGS. 7A and 7B, data al and data a are compared with each other.

When the result of the comparison shows that the two pieces of data do not match each other, it is determined that the product in question is a counterfeit-product imitating the genuine product, because the scanned image data transmitted from the user does not include a specific image that is attached to only the genuine product. The process then proceeds from step S610 to step S611. In step S611, “YES” indicating that the product in question is a counterfeit product is written in the corresponding determination result field 1004 in the table shown in FIG. 10. At the same time, a determination ID and the date of determination are written in the corresponding determination ID field 1002 and the determination date field 1003 as well.

On the other hand, when the result of the comparison in step S609 shows that the two pieces of data match each other, it is determined that the product in question is a genuine product and the process proceeds from step S610 to step S614. In step S614, “NO” indicating that the product is not a counterfeit product is written in the corresponding determination result field 1004 in the table shown in FIG. 10. At the same time, a determination ID and the date of determination are written in the corresponding determination ID field 1002 and the determination date field 1003 as well.

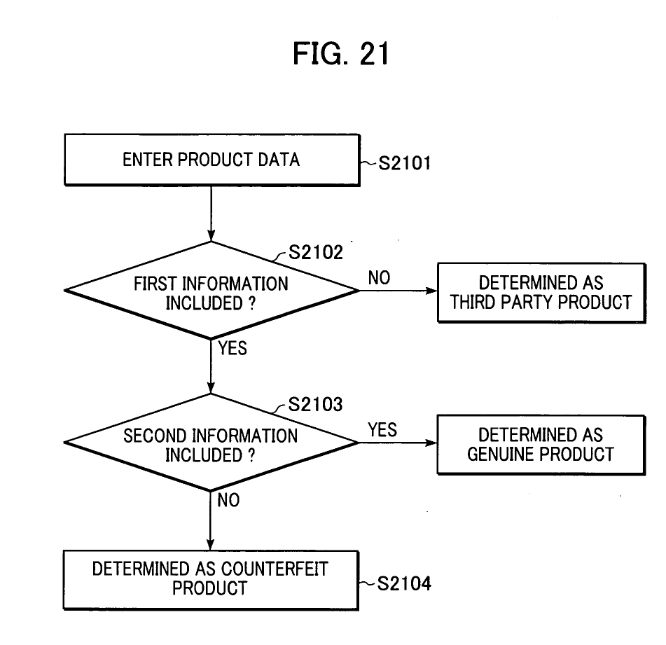

FIG. 21 generally summarizes the counterfeit-product determination processing described above. As shown in FIG. 21, the image processing program 101f of the main server 101 causes a computer to realize a process (step S2101) for inputting image data and product-name data which serve as product data, a process (step S2102) for determining whether or not the input product data includes a registered trademark that is attached to genuine products and that is not attached to third party products as first information, a process (step S2103) for determining whether or not the input product data includes a micro character that is attached to only genuine products as second information for counterfeit protection, and a process (step S2104) for determining that the product in question is a counterfeit product when the input product data includes the first information and does not include the second information. When it is determined NO in step S2102, the product is determined as being a third party product, and when it is determined YES in step S2103, the product is determined as being a genuine product.

Viewing from Authority Terminal

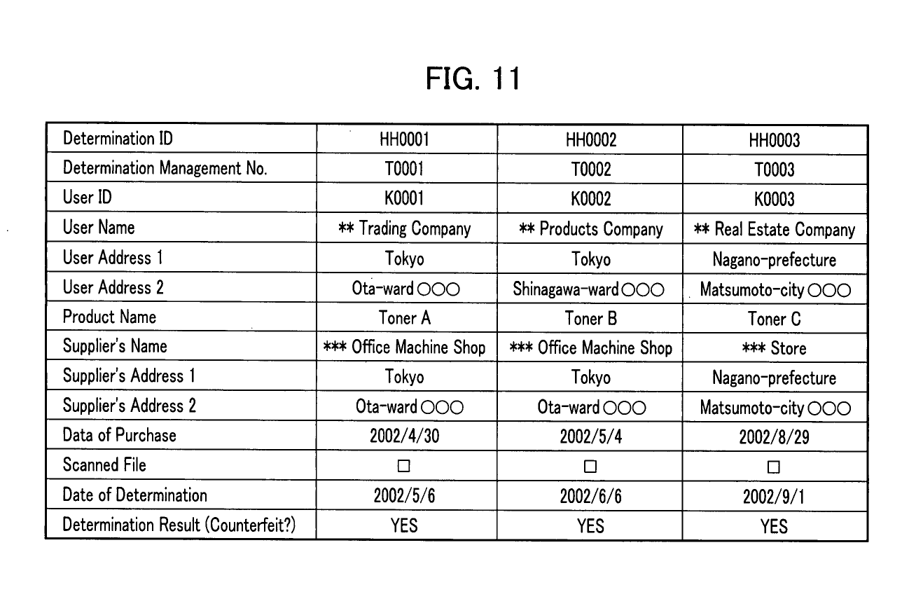

The web browser application 103a of the authority terminal 103 accesses a predetermined URL, as described above, so that a determination result stored in the main server 101 can be downloaded and displayed on the display device at the authority terminal 103. Screens displayed at the authority terminal 103 in this case are shown in FIGS. 11 to 13. FIG. 11 shows a basic screen that can be viewed by the regulatory authority. This screen shows only data that has been determined as data of counterfeit products and that is extracted from the determination result database shown in FIG. 10.

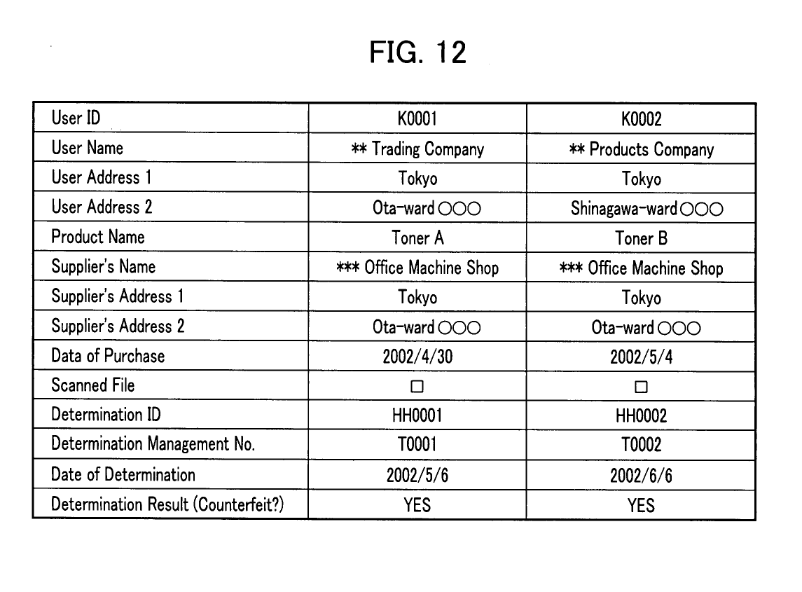

To help the activity of the regulatory authority, the authority terminal 103 may search the determination result database on the main server 101 with the name of a supplier. FIG. 12 illustrates an example of a displayed screen when such a search is performed. Alternatively, a search may be performed with any item, such as a user's address.

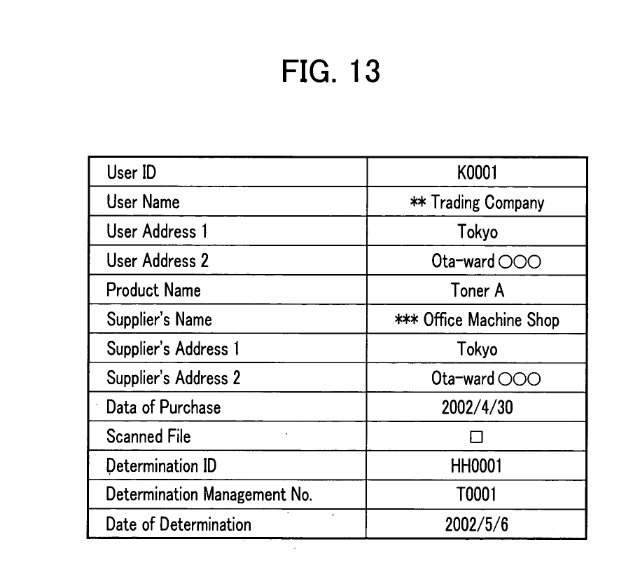

In addition, the authority terminal 103 can search the determination result database on the main server 101 with a combination of conditions of individual items to retrieve desired information. FIG. 13 illustrates an example of a displayed screen when only the determination results showing that a product name is toner A and a purchaser's address 1 is Tokyo are searched for.

Other Embodiments

Although a registered-trademark image has been utilized in the illustrated embodiment to determine that a product is not a third party product, the present invention is not limited thereto.

For example, image information of a manufacture's name, manufacture's address, or the like that can mislead a user to regard a product as being a genuine product may also be used.

Also, although a micro character has been used to determine that a product is a genuine product, the present invention is not limited thereto.

For example, image information of a hologram, a product tag, or the like that cannot be imitated by a counterfeit manufacturer may be used. Alternatively, image information of non-disclosed information, such as a serial number that can be known by only a genuine manufacture and that is shown at a specific location of a product, may be used.

Further, although a scanned image of a product packaging material is input to the main server in the illustrated embodiment, the present invention is not limited thereto. Examples of other product data include a data of product itself, a part thereof, and a part of a document, such as an instruction manual, guarantee, and questionnaire.

The present invention also includes a case in which a software program (a program corresponding to the processing in the flow chart shown in FIG. 2 and/or FIG. 6 and/or FIG. 21 in the illustrated embodiment) that realizes the features of the above-described embodiments is directly or remotely supplied to the system or apparatus and a computer in the system or apparatus reads and executes the supplied program code. In such a case, any form other than a program may be used as long as it has the program's function.

Thus, to achieve the processing for the features of the present invention using a computer, the program code itself that is installed on the computer also constitutes the present invention. Thus, claims of the present invention include the computer program for achieving the processing of the features of the present invention.

In this case, as long as the function of the program is provided, any form of the program may be used, such as object code, a program executed by an interpreter, script data supplied to an OS, and the like may be used.

Examples of available storage media for supplying the program include a floppy™ disk, hard disk, optical disk, magnetic optical disk, MO, CD-ROM, CD-R, CD-RW, magnetic tape, nonvolatile memory card, ROM, and DVD (DVD-ROM and DVD-R).

In addition, the program can also be supplied by accessing a website on the Internet using the browser of a client computer and by downloading the computer program of the present invention or a file that is compressed and that has an automatic installing function onto a storage medium, such as a hard disk, from the website. Further, the program of the present invention can be supplied by dividing program code that realizes the program into multiple files and downloading the individual files from different websites. That is, a WWW server that allows a plurality of users to download the program files for realizing the features of the present invention with computers is also encompassed by the claims of the present invention.

Further, storage media, such as a CD-ROM, in which an encrypted version of the program of the present invention is recorded may be distributed to users. In such a case, users who satisfy a predetermined condition may be permitted to download key information for decrypting the encrypted program from a website over the Internet so that the users use the key information to decrypt the encrypted program and to install the resulting program on computers.

Further, not only is the program code that is read from the computer executed to achieve the features of the above-described embodiments, but also an OS or the like that is running on the computer may perform part or all of the actual processing in accordance with an instruction of the program to achieve the features of the embodiments.

Additionally, after the program code read from the recording medium is stored in a memory that is provided in a plug-in board inserted into the computer or an expansion unit connected to the computer, a CPU or the like that is provided in the plug-in board or the expansion unit may perform part or all of the actual processing in accordance with an instruction of the program to achieve the features of the above-described embodiments.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An information processing apparatus for determining whether or not a product is a counterfeit product in accordance with product data, the information processing apparatus comprising:
inputting means for inputting product data;
first determining means for determining whether or not the product data input by the inputting means includes first information that is attached to a genuine product and that is not attached to a third party product;
second determining means for determining whether or not the product data input by the inputting means includes second information that is attached to only the genuine product; and
third determining means for determining that a product is a counterfeit product when the product data input by the inputting means includes the first information and does not include the second information.

2. The information processing apparatus according to claim 1, wherein the product data includes image data.

3. The information processing apparatus according to claim 1, wherein the product data includes image data and the first determining means determines whether or not the image data includes, as the first information, an image that is protected by an intellectual property right held by a manufacture of the genuine product.

4. The information processing apparatus according to claim 3, wherein the image comprises a registered trademark.

5. The information processing apparatus according to claim 1, wherein the product data includes image data and the second determining means determines whether or not the image data includes, as the second information, an image that does not exist in a counterfeit product.

6. The information processing apparatus according to claim 4, wherein the image comprises a micro-character.

7. The information processing apparatus according to claim 1, wherein the inputting means is means for inputting a determination request and the product data from another terminal, and the information processing apparatus further comprises transmitting means for transmitting a determination result obtained by the third determining means to the another terminal.

8. The information processing apparatus according to claim 1, wherein the product data includes item data that indicates a type of product, and the information processing apparatus further includes a first database in which the first information is stored for each type of product and a second database in which the second information is stored for each type of product, and wherein the first determining means searches the first database in accordance with the item data to retrieve the first information and determines whether or not the input product data includes the retrieved first information, and the second determining means searches the second database in accordance with the item data to retrieve the second information and determines whether or not the input product data includes the retrieved second information.

9. The information processing apparatus according to claim 1, further comprising transmitting means for transmitting a determination result to a predetermined terminal when the third determining means determines that the product is a counterfeit product.

10. The information processing apparatus according to claim 1, wherein the inputting means inputs user information, a determination request, and the product data from a user terminal, and the information processing apparatus further comprises transmitting means for transmitting a determination result obtained by the third determining means and the user information to a predetermined terminal.

11. An information processing system for determining whether or not a product is a counterfeit product in accordance with product data, the information processing system comprising:
an information processing apparatus that comprises:
first inputting means for inputting product data;
first determining means for determining whether or not the product data input by the inputting means includes first information that is attached to a genuine product and that is not attached to a third party product;
second determining means for determining whether or not the product data input by the inputting means includes second information that is attached to only the genuine product; and
third determining means for determining that a product is a counterfeit product when the product data input by the inputting means includes the first information and does not include the second information;
a user terminal; and
a counterfeit-product's regulatory authority terminal,
wherein the information processing apparatus determines whether or not the product is a counterfeit product in accordance with product data transmitted from the user terminal, and, when it is determined that the product is a counterfeit product, the information processing apparatus transmits a notification indicating that the product is a counterfeit product to the counterfeit-product's regulatory authority terminal.

12. An information processing method for determining whether or not a product is a counterfeit product in accordance with product data, the information processing method comprising:
an inputting step of inputting product data;
a first determining step of determining whether or not the product data input in the inputting step includes first information that is attached to a genuine product and that is not attached to a third party product;
a second determining step of determining whether or not the product data input in the inputting step includes second information that is attached to only the genuine product; and
a third determining step of determining that a product is a counterfeit product when the product data input in the inputting step includes the first information and does not include the second information.

13. The information processing method according to claim 12, wherein the product data includes image data.

14. The information processing method according to claim 12, wherein the product data includes image data and, in the first determining step, a determination is made as to whether or not the image data includes an image that is protected by an intellectual property right held by a manufacture of the genuine product.

15. The information processing method according to claim 14, wherein the image comprises a registered trademark.

16. The information processing method according to claim 12, wherein the product data includes image data and, in the second determining step, a determination is made as to whether or not the image data includes, as the second information, an image that does not exist in a counterfeit product.

17. A program product comprising:
an inputting step of inputting product data;
a first determining step of determining whether or not the product data input in the inputting step includes first information that is attached to a genuine product and that is not attached to a third party product;
a second determining step of determining whether or not the product data input in the inputting step includes second information that is attached to only the genuine product; and
a third determining step of determining that a product is a counterfeit product when the product data input in the inputting step includes the first information and does not include the second information.

18. The program product according to claim 17, wherein the product data includes image data.

19. The program product according to claim 17, wherein the product data includes image data and, in the first determining step, a determination is made as to whether or not the image data includes, as the first information, an image that is protected by an intellectual property right held by a manufacture of the genuine product.

20. The program product according to claim 19, wherein the image comprises a registered trademark.

21. The program product according to claim 17, wherein the product data includes image data and, in the second determining step, a determination is made as to whether or not the image data includes, as the second information, an image that does not exist in a counterfeit product.
